(19) United States
(12) Patent Application Publication
(10) Pub. No.: US 2023/0206275 A1
(43) Pub. Date: Jun. 29, 2023

(54) MOBILE BROWSING AND SHOPPING APPLICATION

(71) Applicant: Cole Asher Ratias, San Rafael, CA (US)

(72) Inventor: Cole Asher Ratias, San Rafael, CA (US)

(21) Appl. No.: 18/075,243

(22) Filed: Dec. 5, 2022

Related U.S. Application Data
(60) Provisional application No. 63/286,335, filed on Dec. 6, 2021.

(51) Int. Cl. G06Q 30/0207; G06Q 30/0226

(52) U.S. Cl. CPC G06Q 30/0239; G06Q 30/0222; G06Q 30/0231

(57) ABSTRACT

A method for generating incentives to a user as reward for the user’s on-line activities includes (a) tracking a user’s visits to one or more websites, including the duration of each webpage served at each visit and each purchase made; and (b) determining an award of incentives based on a non-deterministic process that takes into account the user’s visits of the websites. The method may be carried out in a server which receives information regarding the user’s visits from an app that is configured to run on a mobile device on which the user carries out the visits to the websites. The incentives are provided to each user as reward credits accumulated in a database accessible from the server. The non-deterministic process is further based on reward credits accumulated independently of the user’s visits.

### CROSS REFERENCE TO RELATED APPLICATIONS

The present application is related to and claims priority of U.S. Provisional Pat. Application (“Provisional Application”), serial no. 63/286,335, entitled “MOBILE BROWSING AND SHOPPING APPLICATION,” filed on Dec. 6, 2021. The Provisional Application is hereby incorporated by reference in its entirety.

### BACKGROUND OF THE INVENTION

### 1. Field of the Invention

The present invention relates to tracking of user on-line activities and facilitating on-line commercial activities, based on data collected from the tracking. In particular, the present invention relates to providing incentives to users of application programs on mobile devices to use on-line services and to make purchases.

### 2. Discussion of the Related Art

Websites of on-line businesses (e.g., retailers, social media services, and news, entertainment and various information service providers) offer incentives to publishers of application programs (“apps”) who direct their users to visit them. Incentive may include, for example, a portion of the advertising revenue derived from the advertising served to the visitors during their visits. Often, when a user makes a purchase of goods or services from such a website, the business may often pay a percentage of the purchase price to the publisher.

### SUMMARY

According to one embodiment of the present invention, a method for generating incentives to a user as reward for the user’s on-line activities includes (a) tracking a user’s visits to one or more websites, including the duration of each webpages served at each visit and each purchase made; and (b) determining an award of incentives based on a non-deterministic process that takes into account the user’s visits of the websites. The method may be carried out in a server which receives information regarding the user’s visits from an app that is configured to run on a mobile device on which the user carries out the visits to the websites. The incentives are provided to each user as reward credits accumulated in a database accessible from the server. The non-deterministic process is further based on reward credits accumulated independently of the user’s visits.

In one embodiment, reward credits are generated in conjunction with each purchase and applied as a discount to that purchase. The method may also allow the user to request for additional award of incentives. In one embodiment, for each request for additional award of incentives a predetermined amount of reward credits are deducted from the user’s accumulated reward credits. The method may provide for the user to acquire the incentives outside of the non-deterministic process. For example, the method may provide for the user to acquire the incentives upon payment of a subscription fee.

In one embodiment, the method handles all on-line operations necessary to complete the purchase transaction. In one embodiment, in conjunction with handling the purchase transaction, the method includes seeking additional incentives from an external transaction independent of the reward credits, such as cryptocurrency transactions.

In one embodiment, the total amount of reward credits to be awarded is determined according to the revenue derived from businesses patronized in the users’ on-line activities. In that embodiment, the present invention provides an equitable and efficient mechanism to share a portion of the revenue with the users, for example, in partial proportion to their loyalty and engagement, while enhancing that experience by the stochastic rewards from the non-deterministic process.

The present invention is better understood upon consideration of the detailed description below in conjunction with the accompanying drawings.

### BRIEF DESCRIPTION OF DRAWINGS

FIG. 1 shows system 100 in which included app 104a may operate, in accordance with one embodiment of the present invention.

FIG. 2(a) shows graphical image 201a generated by app 104a on a display of mobile device 103 during an access to a typical information provider website (e.g., a news service provider, such as CNN), in accordance with one embodiment of the present invention.

FIGS. 2(b) and 2(c) show graphical images 201b and 201c, respectively, generated by app 104a during accesses to typical shopping websites (e.g., on-line retailers, such as amazon.com or target.com) using app 104a, in accordance with one embodiment of the present invention.

FIG. 2(d) shows graphical image 201d which represents a webpage that allows the user to customize the parameters governing reward credits administration, in accordance with one embodiment of the present invention.

FIG. 3(a) illustrates one implementation of app 104a, according to one embodiment of the present invention,

FIG. 3(b) illustrate, in one implementation, the operation of server 102, according to one embodiment of the present invention.

### DETAILED DESCRIPTION OF THE PREFERRED EMBODIMENTS

According to one embodiment of the present invention, the publisher of an app running on a computing device -- such as a desktop computer, a notebook computer, or a mobile device (e.g., a tablet device or a “smartphone”) - may incentivize a user’s on-line activities by providing rewards when the user makes an on-line purchase or uses an on-line service (e.g., various news, information, social media, and other on-line services). Of course, the publisher is motivated by the financial rewards offered by the vendors of the goods or services purchased. The publisher may determine the incentives offered according to the outcome of a game of chance (e.g., a slot machine-like on-line game). Examples of games of chance include any game in which a mechanism varies the reward according to an outcome that is not readily predicted.

The present invention thus takes advantage of the observation that human beings universally experience enjoyment, excitement and attention when they are engaged with a game of chance. Typically, the excitement results from obtaining a large reward - a relatively rare event -- but often has to settle for a lesser one. The outcome of the game of chance need not be primarily random. Some users may find additional challenge in a game whose outcome is also skill-basd, at least to some extent. To engender loyalty to the app, in one embodiment, the app may require an investment by the user in the form, for example, of a subscription fee payment. It is observed that such loyalty is associated with another human behavior - i.e., desiring to maximize the return on an investment (“getting the money’s worth”), as well as to experience the euphoria of winning a game.

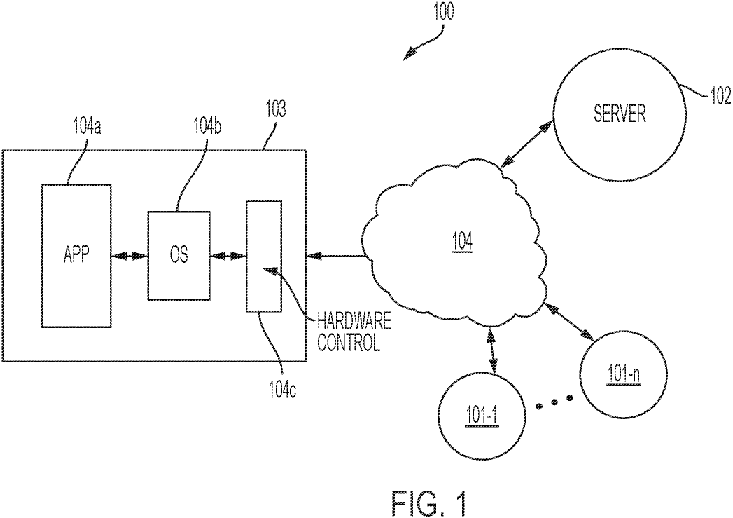

FIG. 1 shows system 100 in which included app 104a may operate, in accordance with one embodiment of the present invention. As shown in FIG. 1, mobile device 103 (e.g., an iPhone from Apple Corporation, or any other smartphone) runs operating system 104b (e.g., the Apple IOS), which provides operating system services to app 104a. In this context, operating system services may include, for example, program interfaces that allow app 104a to access system hardware or software resources on mobile device 103. Examples of such resources include control circuits 104c, which allow app 104a to access peripheral devices, such as communication interfaces to WiFi or cellular networks, a display, a a microphone, speakers, cameras, a touch-sensitive input screen, and various control interfaces (e.g., volume-control and on-off power buttons). Mobile device 103 thus allows a user to carry out unlimited on-line commercial and non-commercial activities and to obtain services from all suitable on-line resources accessible over wide area network 104 (e.g.. the Internet). The present invention is not limited, however, to mobile devices. For example, the user’s activities may be carried out with a desktop computer, or any augmented-reality or virtual-reality device (e.g., “smart glasses”). In FIG. 1, the on-line resources are represented by websites 101-1, 101-2, ..., 101-n. According to this embodiment, app 104a and server 102 participate together in the user’s on-line activities to facilitate and to enhance the user’s on-line experience.

According to one embodiment of the present invention, app 104a tracks visits to sponsored websites (e.g., websites 101-1 to 101-n) and rewards use of services or purchases made at these websites. The rewards are provided in the form of reward credits that can be exchanged for discounts in conjunction with the purchases or be accumulated for future purchases. To generate user excitement, the amount of reward credits awarded in each instance may be determined by a non-deterministic process running on server 102. In this description, a non-deterministic process refers to a randomized or pseudorandomized process. Typically, the outcome may be generated algorithmically according to a probability distribution. Familiar examples of such a non-deterministic process include a lottery or sweepstake-type mechanism or a slot machine-like game. In particular, for maximum experiential impact on the user, the non-deterministic process may be invoked at the time of purchase, with the promise that the award of reward credits generated may be sufficient to cover the purchase price of the item or the service purchased.

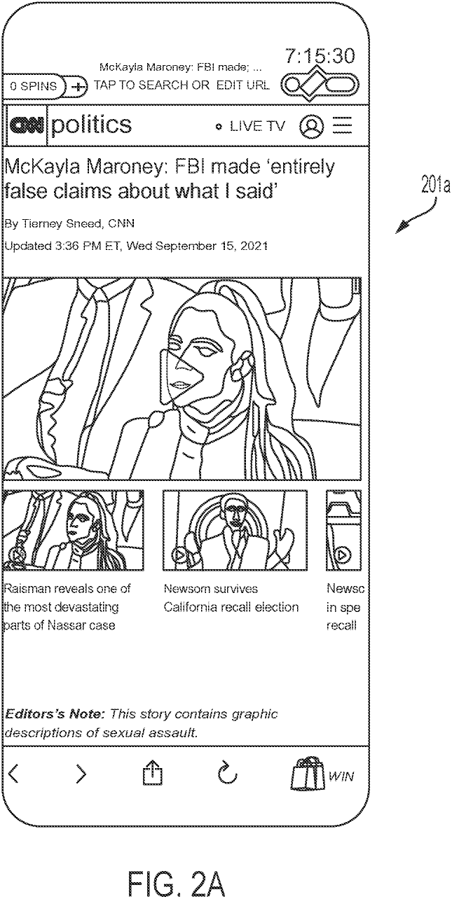

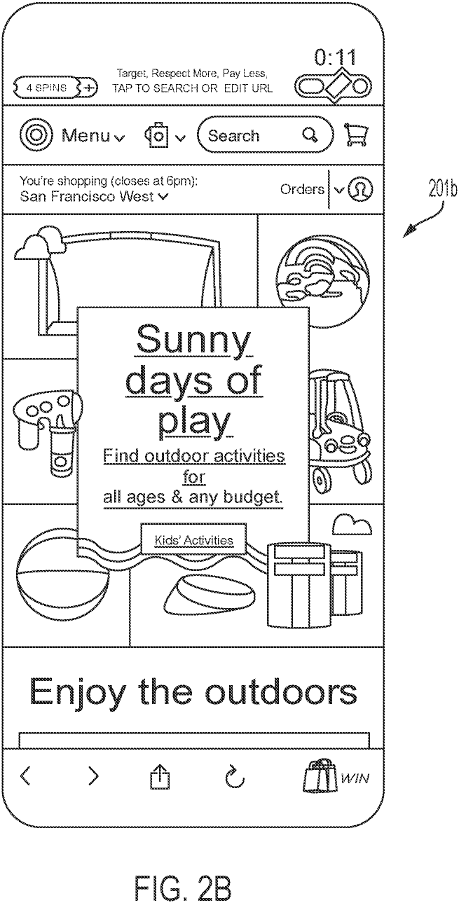

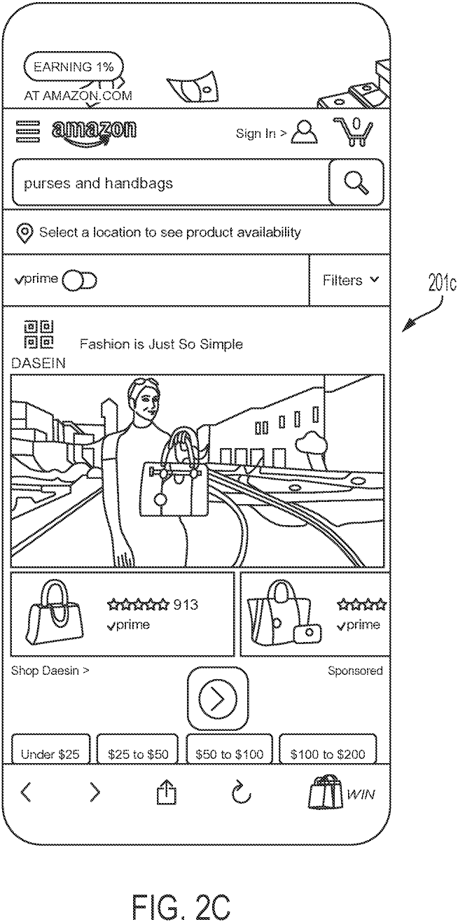

In one embodiment, app 104a operates a browser that enable the user to carry out his or her on-line activities through a conventional interaction user interface. For example, FIG. 2(a) shows graphical image 201a generated by app 104a on a display of mobile device 103 during an access to a typical information provider website (e.g., a news service provider, such as CNN), in accordance with one embodiment of the present invention. Likewise, FIGS. 2(b) and 2(c) show graphical images 201b and 201c, respectively, generated by app 104a during accesses to typical shopping websites (e.g., on-line retailers, such as amazon.com or target.com) using app 104a, in accordance with one embodiment of the present invention.

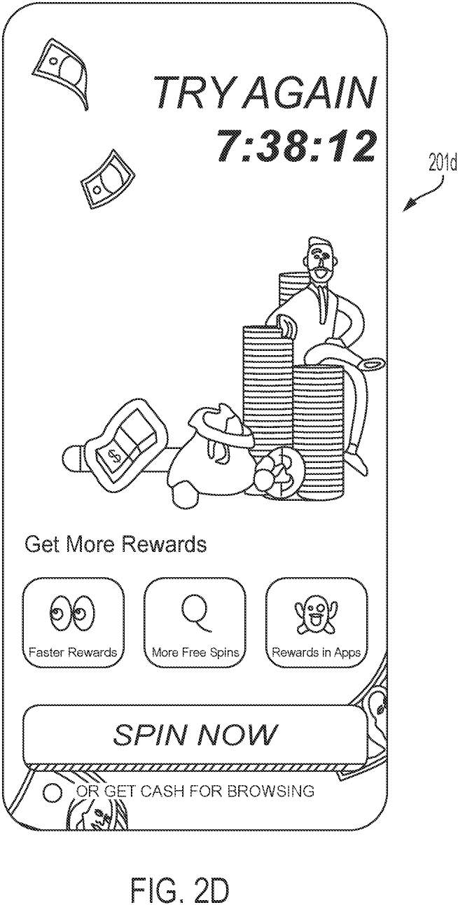

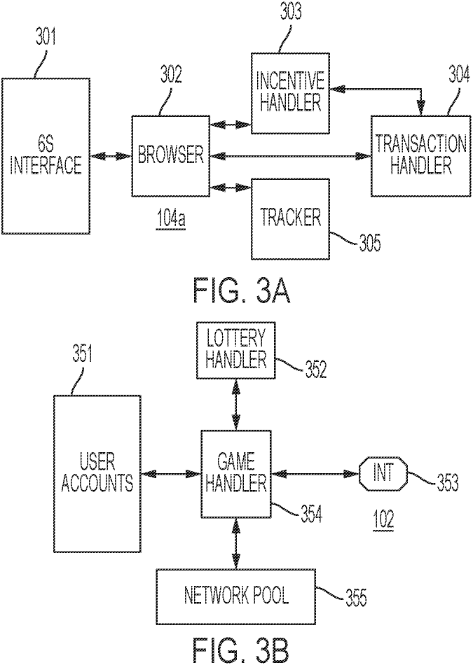

According to one embodiment of the present invention, FIG. 3(a) illustrates one implementation of app 104a. As shown in FIG. 3(a), app 104a includes browser module 302, which communicates with operating system 104b to enable, through a graphical user interface, the user to carry out on-line transactions with his or her desired website. Browser module 302 may invoke tracking module 305 to track the user’s on-line activities. For each website the user visits, for example, tracking module 305 tracks both the webpages visited, including any advertising (e.g., images and videos) displayed, and the duration of the visit associated with each webpage. The collected information may be transmitted over wide area network 104 by tracking module 305 to server 102 for processing. Note that the collected information (e.g., browsing history or other data of interest) may also be stored locally, or even simply locally without being sent to an on-line repository to preserve for privacy. Track module 305 merely requires a way to enable authentication, verification or certification of user identity, and to avoid fraud. In one embodiment, tracking module 305 collects on-line activities (e.g., browsing/history) according to the activity type, regardless of websites visited.

In addition, when the user makes a purchase of goods or services, such as at a retailer website, browser module 302 invokes transaction handler 304, which handles the purchase transaction (e.g.. the “check-out” procedure), including issuing a purchase order to the vendor, and handling the financial arrangement (e.g., a credit card transaction) with appropriate financial institutions. Transaction handler 304 reports the necessary details of the transaction to server 102. Normally, to engender user loyalty, as a matter of course, the user will typically receive an automatic discount of the purchase price from app 104, based on the user’s available reward credits. To further enhance the purchase experience, in carrying out the purchase transaction, transaction handler 304 further invokes incentive module 303, which engages with server 102 to obtain a further reward generated by the non-deterministic process. For example, the outcome of the non-deterministic process may be reward credits sufficient to entirely or in significant part pay for the item or service being purchased.

Note that transaction handler may use a completely customized process to handle order processing (e.g., fulfilment) and payment. Alternately, the process may be handled piecemeal for its varies components, using software development toolkits (“SDK’s”) or application programming interfaces (“API’s”) provided by various service providers.

FIG. 3(b) illustrate one implementation of server 102. according to one embodiment of the present invention. As shown in FIG. 3(b), server 102 includes game handler 354, which communicates with app 104a over network interface 353 to coordinate the reward service to the user. Game handler 354 maintains user account database 351, which stores necessary information of each user, including tracking information received from tracking module 305 and the user’s available reward credits. Based on the tracking information, the publisher of app 104a may receive payments from sponsoring businesses associated with the visited websites and the purchases. In one embodiment, each user is allocated reward credits based on both a user’s own tracking information and the tracking information of all users in the system. For example, a user may receive a predetermined amount of reward credits for a visit to a sponsored website of a predetermined duration (e.g., 20 minutes). When notified of a purchase transaction, game handler 354 may invoke “lottery module” or “outcome generation” module 352 to carry out the non-deterministic process to determine the additional reward credits to be provided to the user for the purchase transaction. In this detailed description, the terms “game handler” and “outcome generation module” (or “lottery module”) are used merely to illustrate the administrative function (e.g., carrying out the rules of the game) and the non-deterministic outcome generation function. In many implementations, both functions can be carried out in the same module, while on other implementations, the functions may be further partitioned to be carried out by a larger number of modules. In one embodiment, outcome generation module 354 may determine the award based not only on information associated with the user’s account, but may include pool database 355, which represents a pool of reward credits accumulated based on tracking information of all users in the system. Such an arrangement allows a user to win an outsized “jackpot” that is not limited by the user’s own available reward credits, thus further increasing attention and excitement in that user’s engagement with the system.

In addition to a purchase of goods or services, game handler 354 may invoke outcome generation module 352 for other desirable activities. For example, the user may be offered a customized discount based on merely interacting with a product offered at a sponsored website (e.g., the user browsing an on-line product catalog) to entice the user to make a purchase. In another example, the user is offered a reward for taking the time to offer a comment or a “like” to a product or service connected to the sponsored website. In one embodiment, game handler 354 may invoke outcome generation module 352 based on the activities engaged by the user at the time. For example, the user may be rewarded a “free spin” for a cryptocurrency reward, when the user registers at a website (e.g., as evidenced by the user providing the user’s email address), or simply for visiting a sponsored website for the first time.

In one embodiment, independent of a purchase transaction, the user may invoke the non-deterministic reward process to obtain additional reward credits. For example, the user is provided, in the lower right corner on each graphical image shown in FIGS. 2(a) to 2(c), an icon denoted “win.”. When browser module 302 detects the user pressing the touch-sensitive screen of the mobile device at the position of the icon, browser module 302 causes incentive module 303 to signal to server 102. In turn, server 102 causes outcome generation module 352 to determine an additional award to the user using the non-deterministic process. To maintain fairness, each time the process is invoked, a predetermined amount of reward credits may be deducted from the user’s account. The user may be awarded “free spins,” for a favorable usage pattern of the system or for “good citizenship.” A free spin allows a user an additional turn at the non-deterministic process to obtain additional reward credits without incurring reward credits. In one embodiment, the user may customize the operations that govern the administration of reward credits. For example, FIG. 2(d) shows graphical image 201d which represents a webpage that allows the user to customize the parameters governing reward credits administration, in accordance with one embodiment of the present invention. As shown in FIG. 2(d), the user may request a faster rate of reward credit accumulation, additional free spins, or reward preferences in specific sponsored websites. The user may spend its available reward credits in exchange for the enhanced privileges. In one embodiment, these enhanced privileges may be obtained by the user paying a subscription fee (e.g., $99).

In one embodiment, outcome generation module 352 manages the total amount of reward credits according to the revenue derived from businesses patronized in the users’ on-line activities. In that embodiment, the present invention provides an equitable and efficient mechanism to share a portion of the revenue with the users, for example, in partial proportion to their loyalty and engagement, while enhancing that experience by the stochastic rewards from the non-deterministic process.

In one example, simultaneously with the handling of the purchase transaction, outcome generation module 352 may search for arbitrage opportunity on cryptocurrency exchanges to finance a greater discount in the purchase price as further reward to the user. To engender a greater user engagement, free spins and limited time-only offers may be awarded to the user on a random basis. In one embodiment, a user may exchange a cryptocurrency obtained from purchase or a mining operation, or non-fungible tokens (NFTs), for tokens that can be used to redeem rewards, or to participate in the game of chance. The system may also offer the user a customized, more advantageous financial model or payment model to the user (e.g., a more favorable financing term), if the purchase decision is made substantially immediately.

In some jurisdictions, a purchase of goods or service cannot be required as a condition for accepting the offer to participate a game of chance. In those jurisdictions, the user may be offer participation by request through mailing a self-addressed, stamped envelope. Also, in some jurisdictions (e.g., Washington or New York), the offer of participation in a game of chance may be either prohibited or permitted only when the reward does not exceed a predetermined value (e.g., $5000). In some embodiments, to reduce the deemed immediate value of the reward, a deferred release time (i.e., a “lockup period”) may be imposed on a reward that is held in or secured by cryptocurrency, using an appropriate discount rate. When the reward exceeds, for example, the associated transaction, the reward may be immediately redeemed, with the over-amount being canceled or reduced. Alternatively, as the deemed reward value may increase or diminish due the fluctuation in the value of the underlying cryptocurrency asset, the lockout period may be changed (e.g., pulled forward, waived or extended) at the user’s option, subject to appropriate rules. The user may also earn additional reward or an appropriately high interest rate, if the user lends the cryptocurrency to the participating cryptocurrency exchange or platform, or allows the user’s mobile or computing devices to be used for cryptocurrency processing or mining operations.

This detailed description is provided to illustrate specific embodiments of the present invention and is not intended to be limiting. Numerous modification and variations within he scope of the present invention are possible. The present invention is set forth in the accompanying claims.

1. A method for generating incentives to a user as reward for the user’s on-line activities, comprising:
tracking a user’s visits to one or more websites, including the duration of each webpage served at each visit and each purchase made; and
determining an award of incentives based on a non-deterministic process that takes into account the user’s visits of the websites.

2. The method of claim 1, wherein the method is carried out in a server which receives information regarding the user’s visits from an app that is configured to run on a mobile device on which the user carries out the visits to the websites.

3. The method of claim 2, wherein the incentives are provided to each user as reward credits accumulated in a database accessible from the server.

4. The method of claim 3, wherein the non-deterministic process is further based on reward credits accumulated independently of the user’s visits.

5. The method of claim 4, further comprising generating reward credits in conjunction with each purchase, and wherein the reward credits generated in conjunction with each purchase are applied as a discount to that purchase.

6. The method of claim 2, further allowing the user to request for additional award of incentives.

7. The method of claim 6, wherein a predetermined amount of reward credits are deducted from the user’s accumulated reward credits for each request for additional award of incentives.

8. The method of claim 1, wherein the method further provides for the user to acquire the incentives outside of the non-deterministic process.

9. The method of claim 7, wherein the method further provides for the user to acquire the incentives upon payment of a subscription fee.

10. The method of claim 1, further comprising handling each purchase transaction in conjunction with each purchase made.

11. The method of claim 10, wherein handling the purchase transaction further comprises seeking additional incentives from an external transaction independent of the reward credits.

12. The method of claim 11, wherein the external transaction comprises a cryptocurrency transaction.
